(19) United States
(12) Patent Application Publication
(10) Pub. No.: US 2002/0103647 A1
(43) Pub. Date: Aug. 1, 2002

(54) Method and apparatus for intelligent message insertion during a call

(76) Inventor: Jean Francois Houplain, Paris (FR)

Correspondence Address: SUGHRUE, MION, ZINN,, MACPEAK & SEAS, PLLC, 2100 PENNSYLVANIA AVENUE, N.W., WASHINGTON, DC, 20037-3213, US

(21) Appl. No.: 09/774,103

(22) Filed: Jan. 31, 2001

(51) Int. Cl. G10L 13/08

(52) U.S. Cl. 704/260

(57) ABSTRACT

An apparatus and method for intelligent message insertion during a targeted telephone or Internet chat room call, that provides a way to identify pre-defined content in conversations of targeted subscribers, and to insert commercial messages, for example, that are targeted either on the basis of subject relevance and/or a previously acquired subscriber profile. The apparatus may employ an automatic speech recognition (ASR) engine and/or an automatic text recognition engine for recognizing a pre-defined word, or sequence of words, and for selecting and inserting relevant and timely messages during a live conversation, according to the content of this conversation. The recognition engine detects words (for example, “holidays”, “flowers”, “pizza”, etc.), as spoken or written by the subscriber and the called party. Based on the detected word or words, and on the subscriber's profile, including a preference history, the system selects the most relevant messages to dynamically insert during the live call for either the calling party and/or called party. Both parties are targeted, not only according to their demographics and preference history, but also as to their expressed interests at the moment.

### FIELD OF THE INVENTION

The present invention relates generally to telephone systems, and specifically to intelligent message insertion during a sponsored, or otherwise serviced, telephone call or Internet chat room communication, based on a subscriber's profile and/or automatic speech or text recognition.

### BACKGROUND OF THE INVENTION

Sponsored telephony allows subscribers free telephone access in exchange for the insertion of commercial messages during their phone calls. Sponsored telephony is known in the art, as exemplified by Iquity Systems' GratisTel service, and allows subscribers to place free calls by dialing a phone number and a GratisTel code. The GratisTel system also allows for both international and cellular calls. A 10-second ad plays before the call is put through, then another ad plays to both parties after one minute, and thereafter at two-minute intervals. If the call recipient is also a subscriber, that message is tailored also for such a situation. A beep signals impending commercial breaks.

Today's technology allows more precise demographic targeting of advertiser's messages. Since sponsored telephony subscribers fill out a questionnaire, including names, addresses, personal habits and tastes, to use the service, advertisers get not only a “captive audience”, but also valuable demographic data in the form of a subscriber profile. Perhaps the greatest traditional problem facing advertisers was described by the New York retailer John Wanamaker, “half of my advertising budget is going to waste, but I don't know which half.”

The subscriber profile is coupled with various consumer behavior parameters built into the system, such as noting at what point in the message the subscriber may react positively, by signaling for more information about the product being advertised, for example. The system allows for further interactivity through e/m/v-commerce where the license holder can send samples, e.g. in the case of a music CD, or can register a product sale through pressing the star(*) button, for example.

Accordingly, the databases in the platform can provide a variety of information about subscribers to advertisers or service providers. The system characteristics can be improved over time, becoming more detailed and customized. For example, advertisers can control campaigns down to the individual level, and register the number of exposures, and thus the number of actual customer contacts, while a particular advertising campaign is in progress. The application can also tailor messages to individual members of a household.

The system allows advertisers to determine the penetration (percent of targeted subscribers that recall an ad—in terms of those immediately responding interactively) and frequency (how often each subscriber is exposed to a particular ad). As a result, advertisers need only pay for the actual exposures achieved, and advertising purchasers are able to reach consumers at reasonable cost, and with a precision not previously possible.

The messages, commercial announcements, for example, are inserted during the phone call, for example, according to the subscriber profile. This profile, provisioned when activating the service, is stored in a database, which is part of the overall system. Alternatively the messages can be provided in the form of a paid service. For example the system may be configured to proactively recognize when a caller is placed on hold or there is a long pause in the conversation. Accordingly, the system can fill such gaps with subscriber prioritized information, such as news headlines, specific news topics, weather, stock report, sports, etc. Such features are preferable to the canned music or business pitch frequently inserted during a hold situation, for example.

The system identifies the caller's identity during the call set-up using CLID (calling-line identification).

Although the subscriber's profile can be improved over time, as described in the prior art above, the criteria used for message choice and insertion is limited. The called party, in particular, may not be a subscriber, and therefore the only known data about the called party is the general geographic location being called. Thus, the messages inserted for the called party are, in terms of prior art, substantially untargetable.

Thus there is a need to provide a sponsored telephony system that recognizes, and responds accordingly to, more timely and targetable information for the purpose of inserting messages corresponding to the subscriber of the system and the called party.

### SUMMARY OF THE INVENTION

Accordingly, it is a principal object of the present invention to overcome the limitations of existing sponsored, or otherwise targeted, telephony systems, and to provide improved methods and apparatus for message insertion.

It is a further object of the present invention to provide improved methods and apparatus for inserting more relevant targeted telephony messages.

It is a still further object of the present invention to provide improved methods and apparatus for inserting targeted telephony messages that record logging information useful to advertisers for marketing purposes.

In accordance with an exemplary embodiment of the present invention, there is provided a system to insert a targeted message into a telephone call over a telephone network between a calling party and a called party, the system comprising:

an automatic speech recognition (ASR) engine coupled to said telephone network and programmed to monitor said telephone call, recognize at least one pre-defined utterance and, if said utterance is recognized, send an indication that said utterance was recognized; and

a message server adapted to said ASR engine, wherein said message server receives information identifying at least one of said parties and, upon receiving said indication that said utterance was recognized, selects said targeted message based on said information and said indication.

In accordance with an alternative exemplary embodiment of the present invention, there is provided a system to insert at least one targeted message during an Internet communication between one or more Internet users, comprising:

a text recognition engine adapted to monitor an internet chat room, for the purpose of recognizing at least one pre-defined word;

a message server adapted to send and receive information and to select at least one targeted message to be inserted based on said at least one pre-defined word that was recognized by said text recognition engine; and

a message insertion engine connected to said Internet chat room, and adapted to insert said at least one targeted message for at least one of said Internet users.

Recognizing these and other objects, the present invention provides a way to identify keyword content in the conversations of targeted telephony subscribers and to insert commercial messages, for example, that are targeted either on the basis of subject relevance and/or a previously acquired subscriber profile. The invention is not limited to inserting commercial messages, however.

By monitoring a conversation and recognizing keywords and pauses, the system can generate and play messages that contain content relevant to the conversation. This content could be based on personal data, such as address book, calendar, to-do list, grocery list, hobbies, etc. For example, upon recognizing, “I wonder what we're doing this weekend,” and a pause, the system could offer to read the caller's calendar. Upon recognizing, “I can't remember Fred's telephone number,” the system could offer to access the caller's personal address book. Thus, the system can act as an electronic assistant that provides information when it recognizes a need for that information. Furthermore, in response to a recognized need, the electronic assistant can perform other, non-verbal, actions, such as adding an item to a to-do list in response to recognizing, “I should pick up some flowers for Jane,” whereupon the assistant interjects, for example, “should I add that to the to-do list, or start a shopping list?”. While personal assistants are well known, and some designers have suggested coupling ASR engines to personal assistants, these systems require a caller to explicitly invoke the personal assistant, e.g. by issuing a “wake up” command. The present invention provides automatic electronic assistance, because the assistant constantly monitors the conversation for keywords or phrases that trigger actions. The assistant can also do Internet-based Web browser searches to provide information from reference sources.

The system, in general, monitors a natural language telephone conversation or e-mail chat, between or among two or more people, and recognizes keywords or phrases that trigger, for example, as a result of artificial intelligence analysis, an action, wherein the keyword or phrase is not a command specifically directed to the system.

A system component for selecting and inserting more relevant and timely messages during a live conversation, according to the content of this conversation, is an Automatic Speech Recognition (ASR) engine. ASR detects pre-defined words, or sequences of words (like holidays, sex, pizza, etc.), as spoken by the subscriber and the called party.

Based on the detected word or words, and on the subscriber's profile, or preference history, the system selects the most relevant messages to dynamically insert during the live call for either calling party or called party, or both, to hear. Thus, the called party no longer remains “the wasted half” of the advertising budget. Both parties are more targeted, not only according to their demographics and preference history, but their expressed interests at the moment, as well.

An example of a chat room can be found at the web site http://www.cash-u.com. This chat service allows one-to-many messaging within communities. The communities can be of special interest or ad hoc groups. Within the wide range of options and possibilities offered by this chat service are:

public/private chats;

a multicast chats;

ongoing/limited time chats;

monitoring transmitted words; and

subscriber blocking.

The availability of consumer-specific demographics, individualized, pinpoint communications networks and automation techniques allowing economies of scale, all combine to diminish the historically lamented waste factor.

Other features and advantages of the invention will become apparent from the following drawings and description.

### BRIEF DESCRIPTION OF THE DRAWINGS

For a better understanding of the invention with regard to the embodiments thereof, reference is made to the accompanying drawings in which like numerals designate corresponding elements or sections throughout, and in which:

FIG. 1 is a block diagram of a system, with intelligent message insertion during a phone call, based on a subscriber profile and automatic speech recognition, in accordance with one exemplary embodiment of the present invention; and

FIG. 2 is a flow chart of an intelligent message insertion system, in accordance with the exemplary embodiment of the present invention depicted in FIG. 1.

### DETAILED DESCRIPTION OF THE PREFERRED EMBODIMENTS

Intelligent message insertion during a targeted telephone or Internet chat room call provides a way to identify pre-defined content in conversations of targeted subscribers, and to insert commercial messages, for example, that are targeted either on the basis of subject relevance and/or a previously acquired subscriber profile. The apparatus employs an automatic speech recognition (ASR) engine and/or an automatic text recognition engine for recognizing a pre-defined word, or sequence of words, and for selecting and inserting relevant and timely messages during a live conversation, according to the content of this conversation. The recognition engine detects words (for example, holidays, flowers, pizza, etc.), as spoken or written by the subscriber and the called party. Based on the detected word or words, and on the subscriber's profile, including a preference history, the system selects the most relevant messages to dynamically insert during the live call for either the calling party or called party, or both, to hear (e.g., via telephone) or see (e.g., via a chat room). Both parties are targeted, not only according to their demographics and preference history, but also according to their expressed interests at the moment.

There is more than one scenario for intelligent message insertion during an inter-party communication over a network. In a preferred embodiment a calling party initiates a call to a specific number corresponding to the intelligent message insertion system service of the present invention, an 800 number, for example. After being connected to this system, and authorized according to calling-line identification (CLI), login/password or other such means, the user dials the called party number using dual tone multi frequency (DTMF, i.e. “touch-tone”) or preferably using speech activation. The system establishes a second leg by calling the called party, and connects the two parties, including activation of of the service comprising speech recognition and message insertion mechanisms.

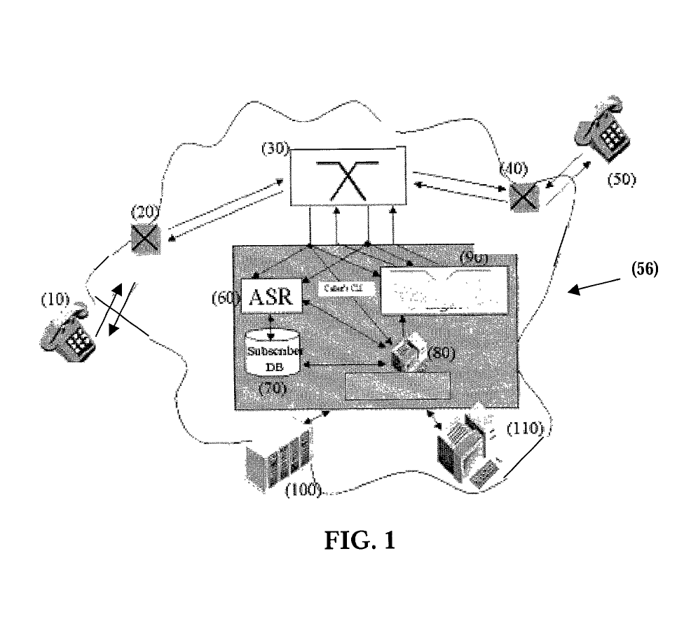

In an alternative embodiment the user calls the called party directly. If the caller is registered to the system, his call is intercepted and routed to the system, and the service is activated. Referring to FIG. 1, there is shown a block diagram of a system for intelligent message insertion during a phone call, based on a subscriber profile and automatic speech recognition, in accordance with one exemplary embodiment of the present invention. The system components are now described.

The intelligent message insertion system 56 operates in a communications environment typically comprising a calling party 10, a calling office local exchange 20, a switching system 30, a called office local exchange 40 and a called party 50.

A phone call from a calling party 10 is routed through a calling office local exchange 20. A switching system 30 switches the trunk from a calling office local exchange 20 to a called office local exchange 40, which, in turn connects to a called party 50.

The message insertion system 56 of the present invention includes the following sub-systems:

A message server 80 that sends a list of words to the speech recognition logic based on the CLI of the calling and/or called parties, and which are derived from their/his respective subscriber profiles. An Automatic Speech Recognition (ASR) engine 60 that monitors the conversation of both the calling and the called parties, and detects pre-defined words or sequences of words stored in an internal database. The detected words are sent to message server 80 as an input for choosing the best message, for example a commercial announcement to insert during the call.

A Subscriber Database 70 contains the subscribers'profile, including, but not limited to, user's name, CLI, hobbies, age, e-mail address, etc. According to the CLI of the subscriber, the user profile is sent to message server 80. As shown in FIG. 1, the caller's CLI is sent to the message server 80, which uses it to select the user profile from the subscriber database 70. The operator can, when such information becomes available, update the subscriber's profile.

During the call set-up, Message Server 80 checks that the user is registered for the service on the basis of the CLI. During the call, message server 80 determines the best messages to insert according to the caller's profile, and/or the words detected by the ASR. Message server 80 sends the intended insertion message to a Message Insertion Engine 90. Message server 80 also schedules message insertion, and controls the duration of the call in the case of a pre-determined call, for example a free call. The message can be either stored as pre-recorded messages, or as text messages converted with a Text To Speech (TTS) engine.

Message Insertion Engine 90 is connected to switching system 30, and takes care of inserting the newly determined messages for either one or both of the parties, but in any case audible to both parties.

The external telephone network system that takes care of routing the specific calls of the targeted message insertion system 56, can be one of several well-known implementations.

Message insertion system 56 organizes communications in conjunction with any of various configurations of network equipment 100. Message insertion system 56 functions for either a Public Switched Telephone Network (PSTN) or a Public Land Mobile Network (PLMN). For the case of a PLMN, a location server 110 is incorporated in the loop of operation, and which can provide the location of the caller at any time to the system, so that the inserted messages can be even more targeted.

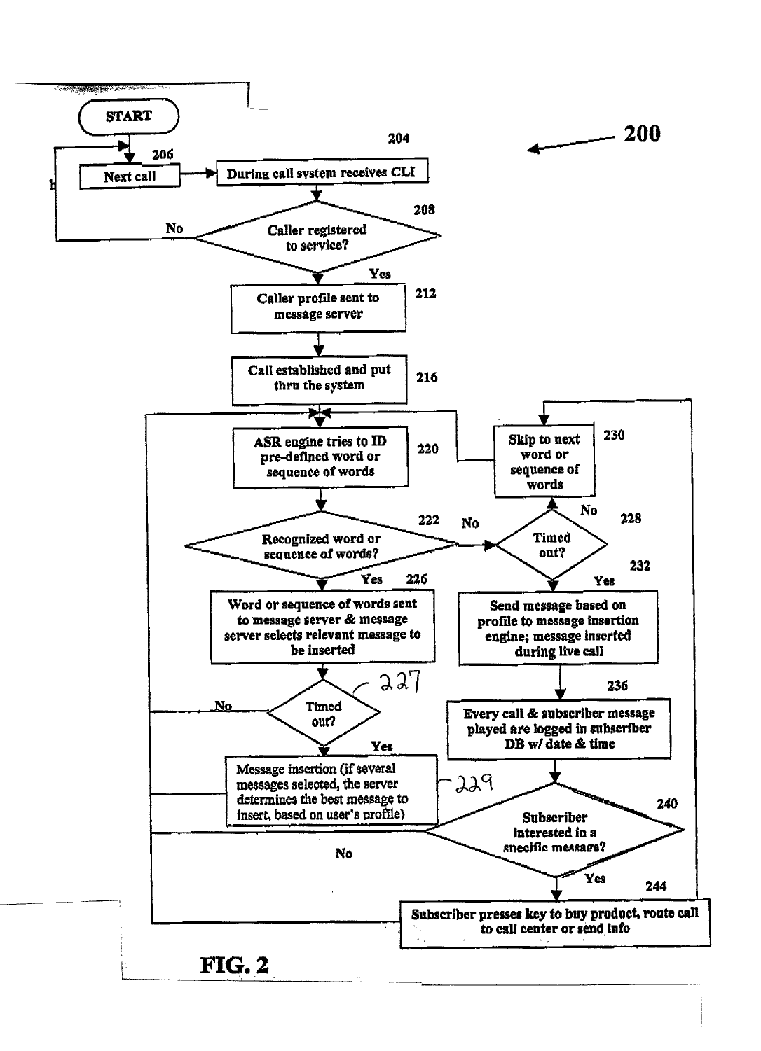

FIG. 2 is a flow chart of an intelligent message insertion system 200, in accordance with an exemplary embodiment of the present invention depicted in FIG. 1.

The following is a typical scenario:

During the call set-up, the system receives the CLI in block 204 and in block 208 checks if the caller is registered for the service. If so, the caller's profile is sent to the message server 80 in block 212 and the call is established to the caller.

In an exemplary embodiment the caller dials a fixed number, an 800 toll free number for example, and the call is routed to the system. After authentication by the service, the caller dials the number of the called party, and the system establishes a second leg to the caller and bridges the calling and called parties.

In a preferred embodiment intelligent network features are implemented.

If the caller is not registered for the service, the system waits for the next call in block 206. Once the call is established, and is going through the system in block 216, the Automatic Speech Recognition engine 60 in block 220 tries to identify pre-defined words or sequences of words.

If a word or sequence of words is recognized in block 222, it is sent to the message server 80 and the message server 80 selects the most relevant message to be inserted during the call, from a pre-defined list stored on the message server, or in an external database, as in block 226. The message is inserted in block 229 after a timed-out period in block 227. The termination from either the calling or the called party stops the message insertion process. Optionally, the choice of the most relevant message can be made in conjunction with the subscriber's profile. In case no word has been recognized by the ASR 60, and time has not run out, as decided in block 228, for a new message to be selected and run, the next word or sequence of words is checked for recognition in block 230.

According to natural ASR technology currently available, from Intouch™, Philips™, e.g., the ASR 60 is done in real time “on the fly”. A new message can be inserted periodically (every minute, for example). Therefore, the message inserted may be based on the word detected during the last period of time. If no word was detected, a message based on the subscriber's profile, may be inserted. If time has run out in block 228, then only the subscriber profile is used for selecting a message as in block 232. With a predefined time schedule (every minute, for example), the message to be inserted is sent to the Message Insertion Engine 90, which inserts the message during the live call.

For every call and every subscriber, the messages played can be logged in the subscriber DB 70 with additional information (date and time of insertion, etc.) in order to keep a history of the messages sent to the subscriber for marketing purpose as in block 236.

Optionally, if the subscriber finds a specific message interesting, as in block 240, he can type a specific key (for example *, #, 1, etc, according to prompts built into the message, or pronounce a key word identifiable by the ASR) in order to perform a specific action, as in block 244, for example to:

buy a product/service, for example;

route the call to a call center; and/or

send information/product description to the subscriber's and/or called party's home, office, etc., or to his e-mail address (stored in the subscriber DB 70).

The invention provides methods and apparatus for inserting targeted telephony messages that are more relevant, with the ability to record logging information useful to advertisers for marketing purposes.

In another embodiment, message insertion system 56 can be further simplified to handle situations where both the caller and the called parties are not subscribers, and are therefore not known by the system. In this embodiment, the caller dials into message insertion system 56. The caller is then connected to the called party. ASR 60 monitors the conversation between the caller and the called party, as previously described. Message insertion system 56, as before, selects targeted messages to insert based only on the conversation as monitored by ASR 60.

Once ASR 60 detects pre-defined words, or sequences of words, message server 80 chooses the best or most appropriate targeted massage to be inserted by message insertion engine 90. In this embodiment, there is no need for subscriber database 70 or subscriber profile information as described in the previous embodiment. Otherwise, this embodiment maintains all of the advantages, features and caller interaction of the previous embodiment.

In yet another embodiment, message insertion system 56 is applied to Internet users. In this type of embodiment, conversations and discussions of Internet users are monitored, and targeted messages are inserted based on their conversations or discussions. Chat rooms conversations are monitored mainly to block “bad language” or avoid inappropriate themes from being raised. One example of such a chat room can be found at the web site http://www.cash-u.com. By choosing “Game list” from this web site you get to such a “chat room”.

It is currently well known for people to communicate via the Internet, for example in chat rooms. It is also well known to monitor the words and language used in chat rooms. This embodiment would use a similar word monitoring system as used to monitor the conversations of the chat room participants. In the chat room embodiment, instead of an ASR 60, the system would include a text recognition engine to detect certain pre-defined words or sequences of words. Once such a pre-defined element is recognized, message server 80 chooses a targeted message to send to a particular person in the chat room, or, alternatively to everyone in the chat room. This targeted message is inserted by message insertion engine 90 similarly to that described hereinabove, but adapted to insert a text message to the screen of the chat room participant or participants. This embodiment also combines subscriber database 70 to keep profiles on the Internet users or any other information that may be desirable to advertisers.

It will be appreciated that the preferred embodiments described above are cited by way of example, and that the present invention is not limited to what has been particularly shown and described hereinabove. Rather, the scope of the present invention, as defined by the appended claims, includes both combinations and sub-combinations of the various features described hereinabove, as well as variations and modifications thereof, which would occur to persons skilled in the art upon reading the foregoing description, and which are not disclosed in the prior art.

I claim:

1. A system for inserting a targeted message into an inter-party communication over a network, the system comprising:
a content-monitoring engine, coupled to said network, for monitoring said inter-party communication, and for recognizing at least one pre-defined word of the communication; and
a message server coupled to said content-monitoring engine, for selecting a targeted message based on the at least one pre-defined word recognized by said content-monitoring engine.

2. The system of claim 1, wherein said inter-party communication is a telephone call between a calling party and a called party over a telephone network, and said content-monitoring engine is an automatic speech recognition (ASR) engine.

3. The system of claim 1, wherein said inter-party communication is an Internet communication chat room, and wherein said content-monitoring engine is a text recognition engine.

4. The system of claim 1, further comprising a database for storing subscriber profile information, wherein said message server determines whether at least one party of the inter-party communication is a subscriber, and when said message server determines that at least one party is a subscriber, said message server selects a targeted message based both on the least one recognized word and the stored subscriber information.

5. The system of claim 4, wherein said at least one pre-defined word is a speech word.

6. The system of claim 1, further comprising a message insertion engine, coupled to the network, for inserting said targeted message into the inter-party communication.

7. The system of claim 6, wherein said message server includes a timer for determining when to insert the targeted message.

8. The system of claim 1, wherein said at least one targeted message is a commercial message.

9. The system of claim 1, wherein said at least one targeted message is an informational message.

10. The system of claim 1, wherein said at least one targeted message is stored as a pre-recorded message.

11. The system of claim 1, further comprising a Text-To-Speech engine, and wherein the targeted message is stored as a text message, and converted to a speech message by said Text-To-Speech engine.

12. A method for inserting a targeted message during an inter-party communication, comprising:
monitoring an inter-party communication;
recognizing at least one pre-defined word communicated during the inter-party communication;
sending said at least one pre-defined word to a message server;
selecting an appropriate targeted message by said message server based on said recognized at least one pre-defined word; and
inserting said selected targeted message during the inter-party communication.

13. The method of claim 12, wherein said inter-party communication is a telephone call between a calling party and a called party, and further comprising identifying at least one of the calling and called parties, and wherein said selection of the targeted message is also based on the identified at least one calling and called parties.

14. The method of claim 13, wherein said calling party is identified with a calling line ID.

15. The method of claim 12, further comprising checking that at least one party of the inter-party communication is a registered party.

16. The method of claim 12, further comprising logging information in a database about the inter-party communication.

17. The method of claim 12, and further comprising logging information on a database about the targeted message.

18. The method of claim 12, further comprising inputting, by at least one party of the inter-party communication, information in response to an inserted targeted message.

19. The method of claim 12, wherein at least one party of the inter-party communication is a subscriber, and wherein said message server selects the targeted message based on the subscriber's profile.

20. The method of claim 12, wherein said targeted message is selected in real-time.

21. The method of claim 12, wherein said inter-party communication is conducted over a Public Switched Telephone Network.

22. The method of claim 12, wherein said inter-party communication is conducted over a Public Land Mobile Network.

23. The method of claim 12, wherein said inter-party communication is an Internet chat room.

24. The method of claim 23, wherein said at least one pre-defined word is a text word.

25. A system to insert a targeted message during an Internet communication between one or more Internet users, comprising:
a text recognition engine adapted to monitor an Internet chat room, and to recognize at least one pre-defined word;
a message server to select a targeted message to be inserted based on said at least one predefined word recognized by said text recognition engine; and
a message insertion engine connected to said internet chat room, and adapted to insert said selected targeted message for at least one of said Internet users.

26. The system of claim 25 further comprising a database for storing user information.

27. The system of claim 26, wherein said message server also uses information from said database in selecting said targeted message.

28. The system of claim 25, wherein, said message server includes a timer for determining when to insert said targeted message.

29. The system of claim 25, wherein said targeted message is a commercial message.

30. The system of claim 25, wherein said targeted message is an informational message.

31. The system of claim 25, wherein said at least on targeted message is stored as a pre-recorded message.

32. The system of claim 25, wherein said message server selects said targeted message in real-time.

33. A computer program product for inserting a targeted message during a call between at least two parties, the product comprising a computer-readable medium having program instructions stored thereon, which instructions, when read by a computer, cause the computer to:
monitor said call;
recognize a pre-defined communication from at least one of said parties;
send said communication to a message server;
select an appropriate targeted message by said server based on said recognized communication; and
insert said targeted message during said call.

34. The computer program of claim 33, wherein the pre-defined communication is recognized by identifying information that identifies at least one of said parties, and the targeted message is selected based on said identifying information.

35. The computer program of claim 34, wherein said call is a telephone call, and said identifying information is a calling line ID.

36. The computer program of claim 33, wherein the instructions cause the computer to check that said at least one of the parties is a registered party.

37. The computer program of claim 33, wherein the instructions cause the computer to log information about said call on a database.

38. The computer program of claim 33, wherein the instructions cause the computer to log said targeted message on a database.

39. The computer program of claim 33, wherein the instructions cause the computer to receive an input by at least one of said at least two parties in response to an inserted targeted message during the call.

40. The computer program of claim 33, wherein the instructions cause the computer to send a subscriber profile to said message server for selecting said targeted message.

41. The computer program of claim 33, wherein the instructions cause the computer to select the targeted message in real-time.

42. The computer program of claim 33, wherein the instructions cause the computer to insert a targeted message over a Public Switched Telephone Network.

43. The computer program of claim 33, wherein the instructions cause the computer to insert a targeted message over a Public Land Mobile Network.

44. The computer program of claim 33, wherein the instructions cause the computer to insert a targeted message over an interconnected Public Switched Telephone Network and Public Land Mobile Network.

45. The computer program of claim 33, wherein the instructions cause the computer to insert a targeted message in an Internet chat room.

46. The computer program of claim 33, wherein the call is a telephone call.

47. The computer program of claim 33, wherein the targeted message is a voice message.

48. The computer program of claim 33, wherein the call is an Internet chat room.

49. The computer program of claim 48, wherein the targeted message is a text message.

50. A system to insert a targeted message into a telephone call over a telephone network between a calling party and a called party, the system comprising:
an automatic speech recognition (ASR) engine coupled to said telephone network, and programmed to monitor said telephone call, recognize at least one pre-defined utterance and, if said utterance is recognized, send an indication that said utterance was recognized; and
a message server, coupled to said ASR engine, for receiving information identifying at least one of said parties and, upon receiving said indication that said utterance was recognized, generating said targeted message based on said information and said indication.
